(19) United States
(12) Patent Application Publication
(10) Pub. No.: US 2026/0052547 A1
(43) Pub. Date: Feb. 19, 2026

(54) SYSTEMS, METHODS, AND DEVICES FOR SIDELINK DCI 3_0 FOR RESOURCE SELECTION MODE 1

(71) Applicant: Apple Inc., Cupertino, CA (US)

(72) Inventors: Huaning Niu, San Jose, CA (US); Chunhai Yao, Beijing (CN); Chunxuan Ye, San Diego, CA (US); Wei Zeng, Saratoga, CA (US); Hong He, San Jose, CA (US); Oghenekome Oteri, San Diego, CA (US); Weidong Yang, San Diego, CA (US); Dawei Zhang, Saratoga, CA (US); Sigen Ye, San Diego, CA (US)

(21) Appl. No.: 19/101,720

(22) PCT Filed: Aug. 12, 2022
(86) PCT No.: PCT/CN2022/112310

§ 371 Date: Feb. 6, 2025

(51) Int. Cl. H04W 72/25; H04L 27/26; H04W 72/232

(52) U.S. Cl. CPC H04W 72/25; H04L 27/2678; H04W 72/232

(57) ABSTRACT

The techniques described herein provide solutions for enabling sidelink (SL) unlicensed band or spectrum (SL-U) communications via SL downlink control information (DCI) 3_0 for resource selection mode 1. The SL DCI 3_0 may include frequency resource assignment information, time resource assignment information, clear channel assessment (CCA) type information, time gap information, and cyclic prefix (CP) extension information, and more. A partial bandwidth (BW) or full BW may be allocated to a user equipment (UE) and multi transition time interval (multi-TTI) scheduling may be used. Multiple SL transmission starting positions may be used and may be continuous or non-continuous. Bi-directional SL DCI 3_0 may also be transmitted to multiple UEs.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks may be developed to implement fifth generation (5G) or new radio (NR) technology, sixth generation (6G) technology, and so on. Such technology may include solutions for enabling user equipment (UE) to communicate with one another directly.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example network according to one or more implementations described herein.

FIG. 2 is a diagram of an example process of sidelink (SL) downlink (DL) control information (DCI) 3_0 for resource selection mode 1 according to one or more implementations described herein.

FIG. 3 is a diagram of an example data structure for SL DCI 3_0 for resource selection mode 1 according to one or more implementations described herein.

FIG. 4 is a diagram of an example of an SL communication based on DCI 3_0 for partial bandwidth (PBW) and full bandwidth (FBW) scenarios according to one or more implementations described herein.

FIG. 5 is a diagram of an example of an SL communication based on DCI 3_0 with multi transmission time interval (multi-TTI) scheduling according to one or more implementations described herein.

FIG. 6 is a diagram of an example of an SL communication based on DCI 3_0 with multiple starting positions according to one or more implementations described herein.

FIG. 7 is a diagram of an example of SL communications based on bi-directional DCI 3_0 according to one or more implementations described herein FIG. 8 is a diagram of an example of control plane protocol stack in accordance with one or more implementations described herein.

FIG. 9 is a block diagram illustrating components, according to one or more implementations described herein, able to read instructions from a machine-readable or computer-readable medium (e.g., a non-transitory machine-readable storage medium) and perform any one or more of the methodologies discussed herein.

FIG. 10 is a diagram of an example process for using SL DCI 3_0 according to one or more implementations described herein.

FIG. 11 is a diagram of an example process for providing SL DCI 3_0 according to one or more implementations described herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Telecommunication networks may include user equipment (UEs) capable of communicating with base stations and other network nodes. UEs and base stations may implement various techniques for establishing and maintaining connectivity. In some implementations, UEs may be capable of communicating and connecting with one another directly. Direct communications between UEs may be referred to as device-to-device (D2D) communications, vehicle-to-anything (V2X) communications, sidelink (SL) communications, and so on. UEs may use one or more wireless frequency bands to communicate with different wireless devices. For example, a UE may use a licensed frequency band to communicate with a base station and a non-licensed frequency band to communicate with other UEs. UEs may engage in a resource selection procedure (e.g., SL resource selection) to enable direct communication with other UEs.

SL resource selection, as described herein, may include mode 1 SL resource selection and mode 2 SL resource selection. Mode 1 SL resource selection may include a dynamic grant (DG) and configured grant (CG) of SL resources managed by a base station or other network device. A DG may involve a grant based on a grant request from UE 110. A CG may involve a resource grant without a grant request and may be based on a type of service being provided (e.g., services that have strict timing or latency requirements). In a mode 1 SL resource selection scenario, the network dynamically allocates SL resources to UEs for SL communications. Further, mode 1 SL resource selection may include a type 1 CG or a type 2 CG. A type 1 CG may include a base station using radio resource control (RRC) signaling to indicate one or more wireless carriers or channels, a periodicity of allocated resources, an offset, start, and length of resources (e.g., symbols), a number of repetitions, a transmission power level, etc. A type 2 CG may include a base station providing a more limited amount of CG information via RRC (e.g., a periodicity and number of repetitions) and providing additional SL CG information via downlink (DL) control information (DCI). The CG may include DCI with a SL radio network temporary identifier (SL-RNTI), a SL configured scheduling (CS) RNTI (SL-CS-RNTI), etc. By contrast to the network-managed SL resource selection of mode 1, mode 2 SL resource selection may include resource selection largely performed by the UE. For example, in mode 2 SL resource selection, a base station may provide UE with a pool of potential SL resources, but the UE may perform the sensing (e.g., availability detection), selection, and reservation of the SL resources.

However, currently available SL resource selection or allocation techniques fail to provide a complete or adequate solution to SL resource selection and reservation to enable sidelink operation in unlicensed band. For example, currently available techniques fail to provide adequate solutions for mode 1 SL resource selection or allocation via DCI. For instance, currently available techniques fail to provide solutions for proscribing SL frequency and time domain resources in unlicensed band, time gap information, clear channel assessment (CCA) types, cyclic prefix (CP) extensions, multi transmission time interval (multi-TTI) scheduling, The techniques described herein provide a superior and more complete solution for SL resource selection in the unlicensed spectrum. For example, a base station may send a UE SL DCI 3_0 for resource selection mode 1. The SL DCI 3_0 may include frequency resource assignment information, time resource assignment information, CCA type information, time gap information, and CP extension information. The frequency resource assignment information may indicate whether a partial BW or a full BW is allocated to UE 110, and whether the assigned frequency resources are interlaced waveform resources or continuous waveform resources. The time resource assignment information may include a CCA type to be performed by the UE, a time gap between reception of the SL DCI 3_0 and a first SL transmission, and whether a CP extension is to be used during the SL communications (e.g., between completion of a CCA procedure and a first SL transmission or to ensure a gap between SL transmissions of a shared COT scenario are observed).

The SL DCI 3_0 may also include multi-TTI scheduling information, which may include continuous SL transmissions or non-continuous SL transmissions. In such scenarios, the SL DCI 3_0 may also include HARQ information for one or more of the multi-TTI SL transmissions. In some implementations, SL DCI 3_0 may include multiple starting positions for SL transmissions. The starting positions may start at a slot boundary or start halfway between slot boundaries, and may depend on whether a partial BW or full BW is allocated to the UE. In some implementations, SL DCI 3_0 may include bi-directional SL DCI 3_0 transmitted by a base station to multiple UEs. The UEs may receive the bi-directional SL DCI 3_0 for being within a coverage area of the base station and/or for being with a logical group of UEs determined by the base station.

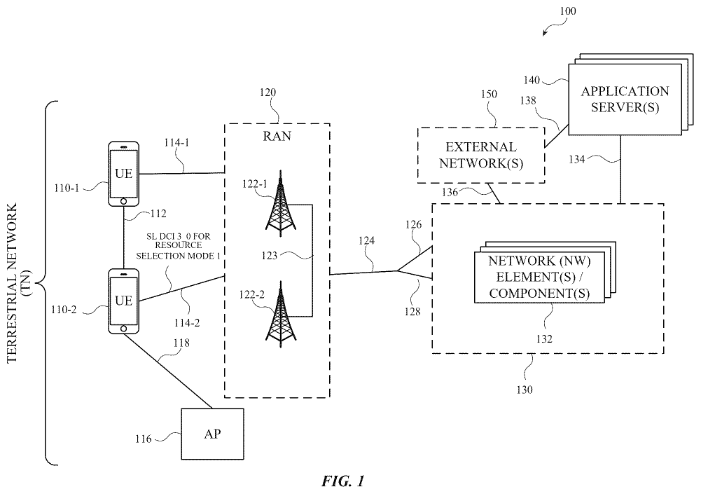

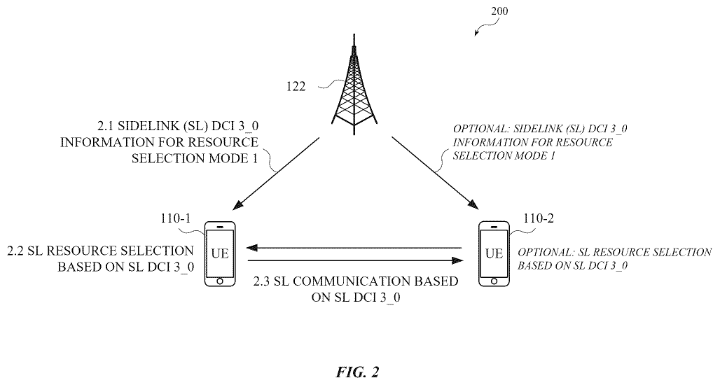

FIG. 1 is an example network 100 according to one or more implementations described herein. Example network 100 may include UEs 110-1, 110-2, etc. (referred to collectively as “UEs 110” and individually as “UE 110”), a radio access network (RAN) 120, a core network (CN) 130, application servers 140, and external networks 150.

The systems and devices of example network 100 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 100 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 110 may include smartphones (e.g., handheld touchscreen mobile computing devices connectable to one or more wireless communication networks). Additionally, or alternatively, UEs 110 may include other types of mobile or non-mobile computing devices capable of wireless communications, such as personal data assistants (PDAs), pagers, laptop computers, desktop computers, wireless handsets, etc. In some implementations, UEs 110 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 110 may communicate and establish a connection with one or more other UEs 110 via one or more wireless channels 112, each of which may comprise a physical communications interface/layer. The connection may include an M2M connection, MTC connection, D2D connection, SL connection, etc. The connection may involve a PC5 interface. In some implementations, UEs 110 may be configured to discover one another, negotiate wireless resources between one another, and establish connections between one another, without intervention or communications involving RAN node 122 or another type of network node. In some implementations, discovery, authentication, resource negotiation, registration, etc., may involve communications with RAN node 122 or another type of network node.

UEs 110 may use one or more wireless channels 112 to communicate with one another. As described herein, UE 110-1 may communicate with RAN node 122 to request SL resources. RAN node 122 may respond to the request by providing UE 110 with a dynamic grant (DG) or configured grant (CG) regarding SL resources. A DG may involve a grant based on a grant request from UE 110. A CG may involve a resource grant without a grant request and may be based on a type of service being provided (e.g., services that have strict timing or latency requirements). UE 110 may perform a clear channel assessment (CCA) procedure based on the DG or CG, select SL resources based on the CCA procedure and the DG or CG; and communicate with another UE 110 based on the SL resources. The UE 110 may communicate with RAN node 122 using a licensed frequency band and communicate with the other UE 110 using an unlicensed frequency band.

UEs 110 may communicate and establish a connection with (e.g., be communicatively coupled) with RAN 120, which may involve one or more wireless channels 114-1 and 114-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 122-1 and 122-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 130. Additionally, at least one of the MN or the SN may be operated with shared spectrum channel access, and functions specified for UE 110 can be used for an integrated access and backhaul mobile termination (IAB-MT). Similar for UE 110, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network node 122.

As described herein, UE 110 may receive and store one or more configurations, instructions, and/or other information for enabling SL-U communications with quality and priority standards. A PQI may be determined and used to indicate a QoS associated with an SL-U communication (e.g., a channel, data flow, etc.). Similarly, an L1 priority value may be determined and used to indicate a priority of an SL-U transmission, SL-U channel, SL-U data, etc. The PQI and/or L1 priority value may be mapped to a CAPC value, and the PQI, L1 priority, and/or CAPC may indicate SL channel occupancy time (COT) sharing, maximum (MCOT), timing gaps for COT sharing, LBT configuration, traffic and channel priorities, and more.

As shown, UE 110 may also, or alternatively, connect to access point (AP) 116 via connection interface 118, which may include an air interface enabling UE 110 to communicatively couple with AP 116. AP 116 may comprise a wireless local area network (WLAN), WLAN node, WLAN termination point, etc. The connection 116 may comprise a local wireless connection, such as a connection consistent with any IEEE 702.11 protocol, and AP 116 may comprise a wireless fidelity (Wi-Fi®) router or other AP. While not explicitly depicted in FIG. 1, AP 116 may be connected to another network (e.g., the Internet) without connecting to RAN 120 or CN 130. In some scenarios, UE 110, RAN 120, and AP 116 may be configured to utilize LTE-WLAN aggregation (LWA) techniques or LTE WLAN radio level integration with IPsec tunnel (LWIP) techniques. LWA may involve UE 110 in RRC_CONNECTED being configured by RAN 120 to utilize radio resources of LTE and WLAN. LWIP may involve UE 110 using WLAN radio resources (e.g., connection interface 118) via IPsec protocol tunneling to authenticate and encrypt packets (e.g., Internet Protocol (IP) packets) communicated via connection interface 118. IPsec tunneling may include encapsulating the entirety of original IP packets and adding a new packet header, thereby protecting the original header of the IP packets.

RAN 120 may include one or more RAN nodes 122-1 and 122-2 (referred to collectively as RAN nodes 122, and individually as RAN node 122) that enable channels 114-1 and 114-2 to be established between UEs 110 and RAN 120. RAN nodes 122 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 122 may include a roadside unit (RSU), a transmission reception point (TRxP or TRP), and one or more other types of ground stations (e.g., terrestrial access points). In some scenarios, RAN node 122 may be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 122, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 122; a media access control (MAC)/physical (PHY) layer split wherein RRC, PDCP, radio link control (RLC), and MAC layers may be operated by the CRAN/vBBUP and the PHY layer may be operated by individual RAN nodes 122; or a “lower PHY” split wherein RRC, PDCP, RLC, MAC layers and upper portions of the PHY layer may be operated by the CRAN/vBBUP and lower portions of the PHY layer may be operated by individual RAN nodes 122. This virtualized framework may allow freed-up processor cores of RAN nodes 122 to perform or execute other virtualized applications.

In some implementations, an individual RAN node 122 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 120 or by a server pool (e.g., a group of servers configured to share resources) in a similar manner as the CRAN/vBBUP. Additionally, or alternatively, one or more of RAN nodes 122 may be next generation eNBs (i.e., gNBs) that may provide evolved universal terrestrial radio access (E-UTRA) user plane and control plane protocol terminations toward UEs 110, and that may be connected to a 5G core network (5GC) 130 via an NG interface.

Any of the RAN nodes 122 may terminate an air interface protocol and may be the first point of contact for UEs 110. In some implementations, any of the RAN nodes 122 may fulfill various logical functions for the RAN 120 including, but not limited to, radio network controller (RNC) functions such as radio bearer management, uplink and downlink dynamic radio resource management and data packet scheduling, and mobility management. UEs 110 may be configured to communicate using orthogonal frequency-division multiplexing (OFDM) communication signals with each other or with any of the RAN nodes 122 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 122 to UEs 110, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 122 may be configured to wirelessly communicate with UEs 110, and/or one another, over a licensed medium (also referred to as the “licensed spectrum” and/or the “licensed band”), an unlicensed shared medium (also referred to as the “unlicensed spectrum” and/or the “unlicensed band”), or combination thereof. In an example, a licensed spectrum may include channels that operate in the frequency range of approximately 400 MHz to approximately 3.8 GHz, whereas the unlicensed spectrum may include the 5 GHz band. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 110 and the RAN nodes 122 may operate using stand-alone unlicensed operation, licensed assisted access (LAA), eLAA, and/or feLAA mechanisms. In these implementations, UEs 110 and the RAN nodes 122 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The LAA mechanisms may be built upon carrier aggregation (CA) technologies of LTE-Advanced systems. In CA, each aggregated carrier is referred to as a component carrier (CC). In some cases, individual CCs may have a different bandwidth than other CCs. In time division duplex (TDD) systems, the number of CCs as well as the bandwidths of each CC may be the same for DL and UL. CA also comprises individual serving cells to provide individual CCs. The coverage of the serving cells may differ, for example, because CCs on different frequency bands will experience different pathloss. A primary service cell or PCell may provide a primary component carrier (PCC) for both UL and DL and may handle RRC and non-access stratum (NAS) related activities. The other serving cells are referred to as SCells, and each SCell may provide an individual secondary component carrier (SCC) for both UL and DL. The SCCs may be added and removed as required, while changing the PCC may require UE 110 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different physical uplink shared channel (PUSCH) starting positions within a same subframe. To operate in the unlicensed spectrum, UEs 110 and the RAN nodes 122 may also operate using stand-alone unlicensed operation where the UE may be configured with a PCell, in addition to any SCells, in unlicensed spectrum.

The PDSCH may carry user data and higher layer signaling to UEs 110. The physical downlink control channel (PDCCH) may carry information about the transport format and resource allocations related to the PDSCH channel, among other things. The PDCCH may also inform UEs 110 about the transport format, resource allocation, and hybrid automatic repeat request (HARQ) information related to the uplink shared channel. Typically, downlink scheduling (e.g., assigning control and shared channel resource blocks to UE 110-2 within a cell) may be performed at any of the RAN nodes 122 based on channel quality information fed back from any of UEs 110. The downlink resource assignment information may be sent on the PDCCH used for (e.g., assigned to) each of UEs 110.

The PDCCH uses control channel elements (CCEs) to convey the control information, wherein several CCEs (e.g., 6 or the like) may consists of a resource element groups (REGs), where a REG is defined as a physical resource block (PRB) in an OFDM symbol.

Before being mapped to resource elements, the PDCCH complex-valued symbols may first be organized into quadruplets, which may then be permuted using a sub-block interleaver for rate matching, for example. Each PDCCH may be transmitted using one or more of these CCEs, where each CCE may correspond to nine sets of four physical resource elements known as REGs. Four quadrature phase shift keying (QPSK) symbols may be mapped to each REG. The PDCCH may be transmitted using one or more CCEs, depending on the size of the DCI and the channel condition. There may be four or more different PDCCH formats defined in LTE with different numbers of CCEs (e.g., aggregation level, L=1, 2, 4, 8, or 16).

In some implementations, UE 110 and store one or more configurations, instructions, and/or other information for SL DCI 3_0 for resource selection mode 1. The SL DCI 3_0 SL DCI 3_0 information may be received from base station 122 and used to conduct communications on SLs unlicensed resources, select resources for transmission over via interface 112, etc. The SL DCI 3_0 may include frequency resource assignment information, time resource assignment information, CCA type information, time gap information, and CP extension information. The frequency resource assignment information may indicate whether a partial BW or a full BW is allocated to UE 110, and whether the assigned frequency resources are interlaced waveform resources or continuous waveform resources. The time resource assignment information may include a CCA type to be performed by the UE, a time gap between reception of the SL DCI 3_0 and a first SL transmission, and whether a CP extension is to be used during the SL communications (e.g., between completion of a CCA procedure and a first SL transmission or to ensure a gap between SL transmissions of a shared COT scenario are observed).

The SL DCI 3_0 may also include multi-TTI scheduling information, which may include continuous SL transmissions or non-continuous SL transmissions. In such scenarios, the SL DCI 3_0 may also include HARQ information for one or more of the multi-TTI SL transmissions. In some implementations, SL DCI 3_0 may include multiple starting positions for SL transmissions. The starting positions may start at a slot boundary, start halfway between slot boundaries, and may depend on whether a partial BW or full BW is allocated to the UE. In some implementations, SL DCI 3_0 may include bi-directional SL DCI 3_0 transmitted by a base station to multiple UEs. The UEs may receive the bi-directional SL DCI 3_0 for being within a coverage area of the base station and/or for being with a logical group of UEs determined by the base station.

Some implementations may use concepts for resource allocation for control channel information that are an extension of the above-described concepts. For example, some implementations may utilize an extended (E)-PDCCH that uses PDSCH resources for control information transmission. The EPDCCH may be transmitted using one or more ECCEs. Similar to the above, each ECCE may correspond to nine sets of four physical resource elements known as an EREGs. An ECCE may have other numbers of EREGs in some situations.

The RAN nodes 122 may be configured to communicate with one another via interface 123. In implementations where the system is an LTE system, interface 123 may be an X2 interface. In NR systems, interface 123 may be an Xn interface. The X2 interface may be defined between two or more RAN nodes 122 (e.g., two or more eNBs/gNBs or a combination thereof) that connect to evolved packet core (EPC) or CN 130, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 110 from an SeNB for user data; information of PDCP PDUs that were not delivered to a UE 110; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 120 may be connected (e.g., communicatively coupled) to CN 130. CN 130 may comprise a plurality of network elements 132, which are configured to offer various data and telecommunications services to customers/subscribers (e.g., users of UEs 110) who are connected to the CN 130 via the RAN 120. In some implementations, CN 130 may include an evolved packet core (EPC), a 5G CN, and/or one or more additional or alternative types of CNs. The components of the CN 130 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 130 may be referred to as a network slice, and a logical instantiation of a portion of the CN 130 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 130, application servers 140, and external networks 150 may be connected to one another via interfaces 134, 136, and 138, which may include IP network interfaces. Application servers 140 may include one or more server devices or network elements (e.g., virtual network functions (VNFs) offering applications that use IP bearer resources with CM 130 (e.g., universal mobile telecommunications system packet services (UMTS PS) domain, LTE PS data services, etc.). Application servers 140 may also, or alternatively, be configured to support one or more communication services (e.g., voice over IP (VOIP sessions, push-to-talk (PTT) sessions, group communication sessions, social networking services, etc.) for UEs 110 via the CN 130. Similarly, external networks 150 may include one or more of a variety of networks, including the Internet, thereby providing the mobile communication network and UEs 110 of the network access to a variety of additional services, information, interconnectivity, and other network features.

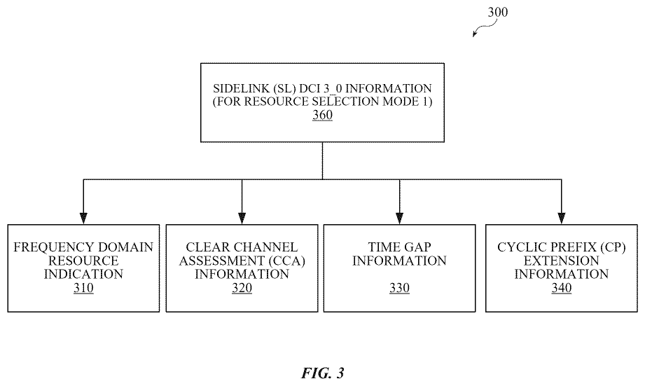

FIG. 2 is a diagram of an example process 200 of SL DCI 3_0 for resource selection mode 1 according to one or more implementations described herein. Process 200 may be implemented by UE 110-1, UE 110-2, and base station 122. In some implementations, some or all of process 200 may be performed by one or more other systems or devices, including one or more of the devices of FIG. 1. Additionally, process 200 may include one or more fewer, additional, differently ordered and/or arranged operations than those shown in FIG. 2. In some implementations, some or all of the operations of process 200 may be performed independently, successively, simultaneously, etc., of one or more of the other operations of process 200. As such, the techniques described herein are not limited to a number, sequence, arrangement, timing, etc., of the operations or process depicted in FIG. 2.

As shown, process 200 may include base station 122 providing UE 110-1 with SL DCI 3_0 information for resource selection mode 1 (at 2.1). Mode 1 SL resource selection may include a dynamic scheduling and CG of SL resources managed by a base station or other network device. In a mode 1 scenario, the network dynamically allocates SL resources to UEs for SL communications. Further, mode 1 SL resource selection may include a type 1 CG or a type 2 CG. A type 1 CG may include a base station using RRC signaling to indicate one or more wireless carriers or channels, a periodicity of allocated resources, an offset, start, and length of resources (e.g., symbols), a number of repetitions, a transmission power level, etc. A type 2 CG may include a base station providing a more limited amount of CG information via RRC (e.g., a periodicity and number of repetitions) and providing additional SL CG information via DCI. A type 1 CG may be cell-specific or UE-specific and configured via RRC configuration of a useInterlacePSFCH-PSSCH value in a SLBWP-Config information element (IE).

In some implementations, base station 122 may send the SL DCI 3_0 information in response to receiving UE capability information from UE 110-1 and/or a request for SL resources. As described herein, the SL DCI 3_0 may include frequency domain resource indication, time gap information, a CCA type, and/or a cyclic prefix (CP) extension. Examples of these are discussed below in greater detail with reference to FIG. 3.

UE 110-1 may receive the SL DCI 3_0 information and select SL resources based on the SL DCI 3_0 information (at 2.2). As described herein, this may include processing the SL DCI 3_0 information, performing a CCA procedure proscribed by the SL DCI 3_0 information, and using assigned SL frequency domain resources to transmit one or more signals to UE 110-2. In some implementations, the SL DCI 3_0 information may also, or alternatively indicate or otherwise enable multi transmission time interval (multi-TTI) scheduling, time domain resources for HARQ procedures, one or more transmission start positions, and more.

UE 110-1 may use the selected resources to communicate with UE 110-2 based on, or in accordance with, the SL DCI 3_0 information and selected resources (at 2.3). UE 110-2 may receive the SL communication from UE 110-1 and respond in a manner that further enables SL communication between the UEs 110. As shown, in some implementations, base station 122 may provide group DCI (e.g., SL DCI 3_0 information for both UE 110-1 and UE 110-2. As described herein, group DCI may enable UE 110-1 and UE 110-2 to each implement the DCI information in communicating with each other (e.g., using shared channels, similar timing information, similar HARQ procedures, etc.).

FIG. 3 is a diagram of an example data structure 300 for SL DCI 3_0 for resource selection mode according to one or more implementations described herein. Data structure 300 may include types of information that may be included in SL DCI 3_0 information 310, which may be provided by base station 122 to one or more UEs 110s. Additionally, any of data structure 300 may be stored and/or processed by UEs 110 to enable one or more of the SL communication techniques described herein. In some implementations, data structure 300 may include one or more fewer, additional, differently ordered, and/or arranged types of information than those shown in FIG. 3. As such, data structure 300 is provided as a non-limiting example of information that may be used to implement one or more of the techniques described herein.

As shown, data structure 300 may include frequency domain resource indication information 310 (also referred to as frequency domain information). Frequency domain resource indication information 310 may include a bit field of one or more bits that indicates one or more frequencies that UE 110 may use for SL communications. In some implementations, the type or arrangement of the bit field may depend on an RRC configuration (e.g., whether the useInterlacePSFCH-PSSCH value of a SLBWP-Config IE is set to true or false). This information may be provided by UE 110 to base station 122 as part of UE capability information or another type of information. As such, frequency domain resource indication information 310 may include an indication of interlaced waveform frequency resources. In such a scenario, the bit field may include a DCI 0-0 bit field for interlaced waveform or a DCI 0-1 bit field for interlaced waveform. Additionally, or alternatively, such as when UE 110 is not capable of using interlaced waveform resources the useInterlacePSFCH-PSSCH value is set to false, frequency domain resource indication information 310 may include an allocation of a continuous waveform frequency resources.

Data structure 300 may also include CCA information 320. CCA information 320 may include a CCA type (e.g., a type 1 CCA or a type 2 CCA) that UE 110 is to perform before using the selected resources for SL communications. In some implementations, the CCA type may be determined by base station 122 in response to, for example, a request for SL resources and/or UE capability information that UE 110 communicated to base station 122 prior to receiving SL DCI 3_0 information 360. In some implementations, SL DCI 3_0 information 360 indicating a type 1 CCA procedure (e.g., energy detection (ED) based) may also include a priority class information to be used by UE 110 in selecting SL resources (e.g., frequency resources, timing resources, etc.). In such scenarios, the priority class information may have been determined by base station 122 based on a SL scheduling request (SR) and/or buffer status report (BSR) received from UE 110. In some implementations, SL DCI 3_0 information 360 may indicate a type 2 CCA procedure (e.g., carrier sense based) when, for example, the scheduled SL transmission is within a COT of another UE 110.

Data structure 300 may also include time gap information 330. Time gap information 330 may include an amount of time that UE 110 is to wait before using resources allocated by SL DCI 3_0 information 360 for SL communications. In some implementations, time gap information 330 may be determined by base station 122 based on the request for SL resources (e.g., a SL scheduling request) and/or UE capability information from UE 110. In some implementations, time gap information 330 may be based on a minimum amount of time that UE 110 may spend processing SL DCI 3_0 information 360 and performing a CCA procedure indicated by SL DCI 3_0 information 360.

Data structure 300 may also include CP extension information 340. CP extension information 340 information may include a CP extension used by UEs 110 for SL communications. In some implementations, a CP extension may be implemented when type 2 CCA is signaled to create a 16 μs or 25 μs gap between shared COT SL communications (e.g., upon receiving a signal from UE 110-1, UE 110-2 may implement a CP extension to create a proscribed gap between shared COT SL communications). In some implementations, a CP extension may be used when type 1 CCA is signaled. In such scenarios, a CP extension may not be enabled for PBW scenarios (e.g., scenarios in which a CG from base station 122 involves a PBW). By contrast, a CP extension may be enabled for FBW scenarios (e.g., scenarios in which a CG from base station 122 involves an FBW).

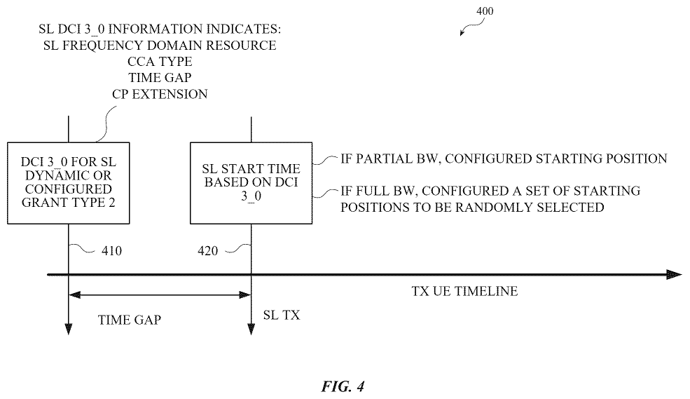

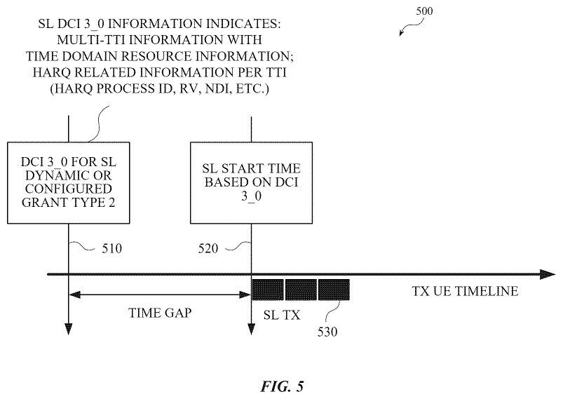

FIG. 4 is a diagram of an example 400 of an SL communication based on DCI 3_0 for PBW and FBW scenarios according to one or more implementations described herein. As shown, example 400 includes a transmission (Tx) UE timeline that includes several events and features (e.g., 410, 420, time gap, SL Tx, etc.). The events and features of example 400 may represent processes, operations, datasets, etc., that may involve one or more devices described herein, such as UEs 110 and/or base station 122. In some implementations, example 400 may include one or more fewer, additional, differently ordered, or arranged events and features than those shown in FIG. 4. For example, in some implementations, the events and features of example 400 may be combined with, modified by, or substituted for one or more operations, processes, or datasets of one or more other example implementations described herein. As such, example 400 is provided as a non-limiting example that may be used to implement one or more of the techniques described herein.

As shown, example 400 may include a transmitting (Tx) UE 110 (not shown) may receive SL DCI 3_0 information (at 410). In some implementations, the SL DCI 3_0 information may include one or more SL frequency domain resources allocated to Tx UE 110, a CCA type, a time gap, and CP extension. The SL frequency domain resources may include carriers, channels, bands, etc., that Tx UE 110 may use to communicate with a receiving (Rx) UE 110 (not shown). The CCA type may include a CCA type (e.g., a type 1 CCA or a type 2 CCA) that UE 110 is to perform before using the selected resources for SL communications. The time gap may include an amount of time that Tx UE 110 may wait, measured from receiving the SL DCI 3_0 information, before engaging in a SL Tx. As described herein, the time gap may be an amount of time spent by UE 110-1 to process the SL DCI 3_0 information and perform the CCA procedure. The CP extension may indicate whether UEs 110 engaged in SL communications should implement a CP extension to help satisfy timing gaps in SL COT sharing scenarios.

The SL DCI 3_0 information may also indicate whether a partial bandwidth (BW, PBW, or BWP) or a full BW (FBW) is allocated for SL communications. As shown, when one or more partial BW is allocated, the SL DCI 3_0 information may indicate a starting position for the partial BW. In such a scenario, Tx UE 110 may be configured to enable frequency-division multiplexing (FDM), Tx UE 110 may multiplex signals based on an interlaced signaling structure (e.g., where useInterlacePSFCH-PSSCH is set to “true”). Additionally, a starting point configured for a resource pool or CG may be aligned to, for example, avoid one UE 1110 from transmitting earlier and blocking all other FDM transmissions of UEs 110 using the same frequency resource pool. In some implementations, the aligned, or unified, starting position may be provided by base station 122 via dynamic grant.

When a FBW is allocated, the SL DCI 3_0 information may indicate a set of starting positions (configured by base station 122) from which Tx UE 110 may randomly select. In such a scenario, when a 20 megahertz (MHz) BW is allocated to Tx UE 110, 10 and 5 interlaces for 15 and 30 kilohertz (kHz) subcarrier spacing (SCS) may be used, respectively. Additionally, Tx UE 110 may randomly select a position within a first symbol and use CP extension to fill in a remaining half symbol. In some implementations, the signaling described above ay be configured via RRC signaling and/or via DCI 3_0 for a type 2 CG. Tx UE 110 may randomly choose one value from the configured set of starting points after a type 1 LBT success.

FIG. 5 is a diagram of an example 500 of an SL communication based on DCI 3_0 with multi-TTI scheduling according to one or more implementations described herein. As shown, example 500 includes a Tx UE timeline that includes several events and features (e.g., 510, 520, 530, time gap, SL Tx, etc.). The events and features of example 500 may represent processes, operations, datasets, etc., that may involve one or more devices described herein, such as UEs 110 and/or base station 122. In some implementations, example 500 may include one or more fewer, additional, differently ordered, or arranged events and features than those shown in FIG. 5. For example, in some implementations, the events and features of example 500 may be combined with, modified by, or substituted for one or more operations, processes, or datasets of one or more other example implementations described herein. As such, example 500 is provided as a non-limiting example that may be used to implement one or more of the techniques described herein.

As shown, example 500 may include Tx UE 110 (not shown) may receive SL DCI 3_0 information (at 510). In some implementations, the SL DCI 3_0 information may include multi-TTI information with corresponding time domain resource information, and HARQ related information per TTI (such as a HARQ process ID, redundant version (RV), new data indicator (NDI), etc. The multi-TTI information with corresponding time domain resource information may indicate a transmission, and corresponding time domain resources, of the same data multiple times in a row (at 530) to increase the possibility of successful data reception and decoding (e.g., TTI bundling of information via a physical SL control channel (PSCCH) and/or physical SL shared channel (PSSCH). In some implementations, only continuous time domain resources may be used for multi-TTI. In such implementations, the time domain resources allocated may be within an MCOT when access priority is signaled in the SL DCI 3_0 information. In some implementations, the time domain resources allocated may also, or alternatively, include non-continuous time domain resources.

The HARQ related information may include, for each TTI, a HARQ process ID, RV, NDI, etc., to enable the identification of new data, redundant data, and HARQ process ID per HARQ procedure. In this manner, example 500 may enable Tx UE 110 (not shown) to use multi-TTI and corresponding HARQ processes to transmit data (at 520) to Rx UE 110 (not shown). In some implementations, an original HARQ process number and/or HARQ process ID may indicate a first TTI of the multi-TTI transmission. In some implementations, a HARQ ID from the second TTI may be derived from the first TTI by incremental sequency counting. In other implementations, the HARQ process ID for each TTI may be explicitly signaled. Additionally, or alternatively, the HARQ process ID for the first TTI, plus the number of TTIs per transport block (TB), may be signaled to support the repetition-based transmission operation.

In some implementations, the SL DCI 3_0 information may also include one or more SL frequency domain resources allocated to Tx UE 110, a CCA type, a time gap, and CP extension. The SL frequency domain resources may include carriers, channels, bands, etc., that Tx UE 110 may use to communicate with a Rx UE 110. The CCA type may include a CCA type (e.g., a type 1 CCA or a type 2 CCA) that UE 110 is to perform before using the selected resources for SL communications. The time gap may include an amount of time that Tx UE 110 may wait, measured from receiving the SL DCI 3_0 information, before engaging in a SL Tx. As described herein, the time gap may be an amount of time spent by UE 110-1 to process the SL DCI 3_0 information and perform the CCA procedure. The CP extension may indicate whether UEs 110 engaged in SL communications should implement a CP extension to help satisfy timing gaps in SL COT sharing scenarios.

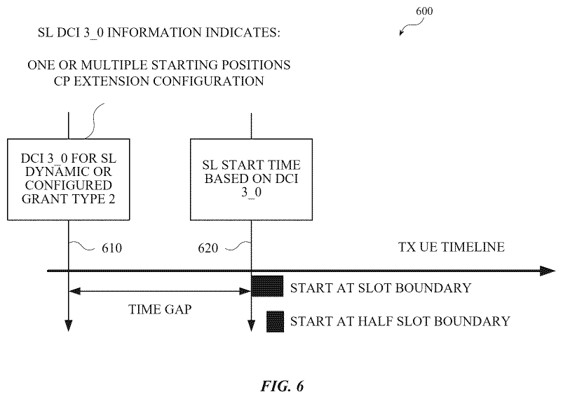

FIG. 6 is a diagram of an example 600 of an SL communication based on DCI 3_0 with multiple starting positions according to one or more implementations described herein. As shown, example 600 includes a Tx UE timeline that includes several events and features (e.g., 610, 620, time gap, SL Tx, etc.). The events and features of example 600 may represent processes, operations, datasets, etc., that may involve one or more devices described herein, such as UEs 110 and/or base station 122. In some implementations, example 600 may include one or more fewer, additional, differently ordered, or arranged events and features than those shown in FIG. 6. For example, in some implementations, the events and features of example 600 may be combined with, modified by, or substituted for one or more operations, processes, or datasets of one or more other example implementations described herein. As such, example 600 is provided as a non-limiting example that may be used to implement one or more of the techniques described herein.

As shown, example 600 may include Tx UE 110 (not shown) may receive SL DCI 3_0 information (at 610). In some implementations, the SL DCI 3_0 information may include an indication of one or more starting positions for SL Tx and corresponding CP extensions. The starting position may include a starting position at a slat boundary (e.g., at a beginning of the slot) and/or a starting position at a half slot boundary (e.g., halfway through a slot). In some implementations, SL DCI 3_0 information indicating one or more starting positions may be used in combination with a multi-TTI implementation as described above with reference to FIG. 5. In such scenarios, each slot may include multiple starting positions for PSCCH and/or PSSCH transmissions after a successful CCA procedure. In some implementations, the starting position may be based one whether a partial BW or a full BW has been allocated for SL Tx. Additionally, or alternatively, a CP extension may be used to fill any additional gap between a successful CCA procedure and a starting position.

Additionally, or alternatively, in a multi-TTI transmission scenario, when a CCA procedure is not successful before the first TTI, Tx UE 110 may perform (or continue performing) another CCA procedure. If the CCA procedure is successful, Tx UE 110 may use the second starting position for the second TTI. In such a scenario, Tx UE 110 may drop the unsuccessful TTI (e.g., end at the same slot for dynamic scheduling). In some implementations, only a full BW scenario with multi-TTI may be permitted to drop an successful TTI, due to an unsuccessful CCA procedure, and start the multi-TTI from the second TTI while ending at the same slot. In partial BW scenarios, this may be limited to 1 slot to avoid blocking or conflicting ither UEs 110 sensing CCA success for multiple TTI. In other implementations, a multi-TTI SL grant may be used for both full BW and partial BW scenarios. In a multi-TTI SL grant and partial BW scenario, a last symbol of each TTI may not be transmitted to ensure of FDM transmissions may perform a successful CCA and transmit using other interlaces. In this manner, example 600 may enable Tx UE 110 (not shown) to use multiple starting points to transmit data (at 620) to Rx UE 110 (not shown).

In some implementations, the SL DCI 3_0 information may also include one or more SL frequency domain resources allocated to Tx UE 110, a CCA type, a time gap, and CP extension. The SL frequency domain resources may include carriers, channels, bands, etc., that Tx UE 110 may use to communicate with a Rx UE 110. The CCA type may include a CCA type (e.g., a type 1 CCA or a type 2 CCA) that UE 110 is to perform before using the selected resources for SL communications. The time gap may include an amount of time that Tx UE 110 may wait, measured from receiving the SL DCI 3_0 information, before engaging in a SL Tx. As described herein, the time gap may be an amount of time spent by UE 110-1 to process the SL DCI 3_0 information and perform the CCA procedure. The CP extension may indicate whether UEs 110 engaged in SL communications should implement a CP extension to help satisfy timing gaps in SL COT sharing scenarios.

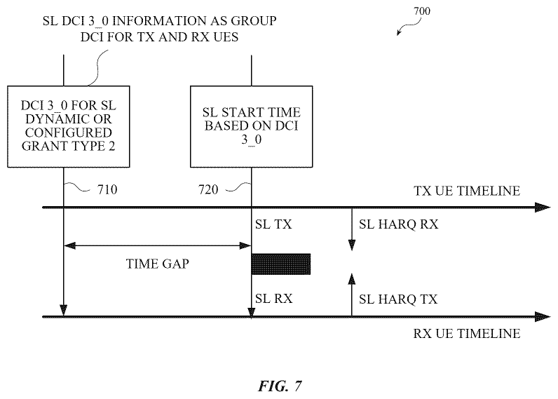

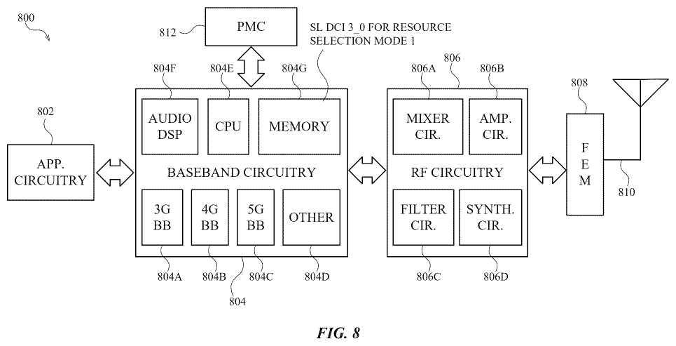

FIG. 7 is a diagram of an example 700 of SL communications based on bi-directional DCI 3_0 according to one or more implementations described herein. As shown, example 700 includes a Tx UE timeline that includes several events and features (e.g., 710, 720, time gap, SL Tx, SL Rx, etc.). The events and features of example 700 may represent processes, operations, datasets, etc., that may involve one or more devices described herein, such as UEs 110 and/or base station 122. In some implementations, example 700 may include one or more fewer, additional, differently ordered, or arranged events and features than those shown in FIG. 7. For example, in some implementations, the events and features of example 700 may be combined with, modified by, or substituted for one or more operations, processes, or datasets of one or more other example implementations described herein. As such, example 700 is provided as a non-limiting example that may be used to implement one or more of the techniques described herein.

As shown, example 700 may include Tx UE 110 (not shown) may receive SL DCI 3_0 information (at 710). In some implementations, the SL DCI 3_0 information may include group DCI for Tx and Rx UEs. For unidirectional DG or CG (as described in examples above) only the UE 110 receiving the grant and DCI may perform a CCA procedure and initiate a COT sharing scenario with a SL Tx. In some implementations, a bi-directional DG or CG may be received by each UE (referred to as a Tx UE and Rx UE in FIG. 7). In such a scenario, two UEs 110 may receive SL DCI 3_0 information indicating the same SL resources for each UE 110. Both UEs 110 may perform a CCA procedure and start a transmission when the CCA procedure is a success. Both UEs 110 may perform type 1 CCA. Since the time to finish type 1 CCA may be random, whichever UE 110 finishes first may start transmission, and in this case, the other UE 110 may be the Rx UE 110 by default.

In some implementations, base station 122 may separately send the same SL DCI 3_0 information to each UE 110. In other implementations, base station 122 may define a group or UEs 110 that include the Tx UE and the Rx UE. Additionally, or alternatively, base station 122 may define SL DCI 3_0 information for UEs 110 in the group. As such, when Tx UE 110 and Rx UE 110 are within a coverage area of base station 122, each UE 110 may receive the same SL DCI 3_0 information for being part of the UE group. Additionally, as shown in FIG. 7, after a time gap and successful CCA, the Tx UE 110 and Rx UE 110 may use the same resources to initiate an SL communication in accordance with the bi-directional SL DCI 3_0 information (at 720). The respective bi-directional communications may include corresponding SL HARQ procedures between Tx UE 110 and Rx UE 110. In some implementations, when only one of the Tx UE 110 or Rx UE 110 is within a coverage area of base station 122, the UE 110 receiving the SL DCI 3_0 information may initiate unidirectional SL communications in accordance with one or more of the other examples (e.g., examples 400, 500, or 600) described herein.

In some implementations, the SL DCI 3_0 information may also include one or more SL frequency domain resources allocated to Tx UE 110, a CCA type, a time gap, and CP extension. The SL frequency domain resources may include carriers, channels, bands, etc., that Tx UE 110 may use to communicate with a Rx UE 110. The CCA type may include a CCA type (e.g., a type 1 CCA or a type 2 CCA) that UE 110 is to perform before using the selected resources for SL communications. The time gap may include an amount of time that Tx UE 110 may wait, measured from receiving the SL DCI 3_0 information, before engaging in a SL Tx. As described herein, the time gap may be an amount of time spent by UE 110-1 to process the SL DCI 3_0 information and perform the CCA procedure. The CP extension may indicate whether UEs 110 engaged in SL communications should implement a CP extension to help satisfy timing gaps in SL COT sharing scenarios.

FIG. 8 is a diagram of an example of components of a device according to one or more implementations described herein. In some implementations, the device 800 can include application circuitry 802, baseband circuitry 804, RF circuitry 806, front-end module (FEM) circuitry 808, one or more antennas 810, and power management circuitry (PMC) 812 coupled together at least as shown. The components of the illustrated device 800 can be included in a UE or a RAN node. In some implementations, the device 800 can include fewer elements (e.g., a RAN node may not utilize application circuitry 802, and instead include a processor/controller to process IP data received from a CN or an Evolved Packet Core (EPC)). In some implementations, the device 800 can include additional elements such as, for example, memory/storage, display, camera, sensor (including one or more temperature sensors, such as a single temperature sensor, a plurality of temperature sensors at different locations in device 800, etc.), or input/output (I/O) interface. In other implementations, the components described below can be included in more than one device (e.g., said circuitries can be separately included in more than one device for Cloud-RAN (C-RAN) implementations).

The application circuitry 802 can include one or more application processors. For example, the application circuitry 802 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 800. In some implementations, processors of application circuitry 802 can process IP data packets received from an EPC.

The baseband circuitry 804 can include circuitry such as, but not limited to, one or more single-core or multi-core processors. The baseband circuitry 804 can include one or more baseband processors or control logic to process baseband signals received from a receive signal path of the RF circuitry 806 and to generate baseband signals for a transmit signal path of the RF circuitry 806. Baseband circuity 804 can interface with the application circuitry 802 for generation and processing of the baseband signals and for controlling operations of the RF circuitry 806. For example, in some implementations, the baseband circuitry 804 can include a 3G baseband processor 804A, a 4G baseband processor 804B, a 5G baseband processor 804C, or other baseband processor(s) 804D for other existing generations, generations in development or to be developed in the future (e.g., 5G, 6G, etc.). The baseband circuitry 804 (e.g., one or more of baseband processors 804A-D) can handle various radio control functions that enable communication with one or more radio networks via the RF circuitry 806. In other implementations, some or all of the functionality of baseband processors 804A-D can be included in modules stored in the memory 804G and executed via a Central Processing Unit (CPU) 804E. The radio control functions can include, but are not limited to, signal modulation/demodulation, encoding/decoding, radio frequency shifting, etc. In some implementations, modulation/demodulation circuitry of the baseband circuitry 804 can include Fast-Fourier Transform (FFT), precoding, or constellation mapping/de-mapping functionality. In some implementations, encoding/decoding circuitry of the baseband circuitry 804 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 804G may receive and store one or more configurations, instructions, and/or other information for SL DCI 3_0 for resource selection mode 1. The SL DCI 3_0 may include frequency resource assignment information, time resource assignment information, CCA type information, time gap information, and CP extension information. The frequency resource assignment information may indicate whether a partial BW or a full BW is allocated to UE 110, and whether the assigned frequency resources are interlaced waveform resources or continuous waveform resources. The time resource assignment information may include a CCA type to be performed by the UE, a time gap between reception of the SL DCI 3_0 and a first SL transmission, and whether a CP extension is to be used during the SL communications (e.g., between completion of a CCA procedure and a first SL transmission or to ensure a gap between SL transmissions of a shared COT scenario are observed).

The SL DCI 3_0 may also include multi-TTI scheduling information, which may include continuous SL transmissions or non-continuous SL transmissions. In such scenarios, the SL DCI 3_0 may also include HARQ information for one or more of the multi-TTI SL transmissions. In some implementations, SL DCI 3_0 may include multiple starting positions for SL transmissions. The starting positions may start at a slot boundary, start halfway between slot boundaries, and may depend on whether a partial BW or full BW is allocated to the UE. In some implementations, SL DCI 3_0 may include bi-directional SL DCI 3_0 transmitted by a base station to multiple UEs. The UEs may receive the bi-directional SL DCI 3_0 for being within a coverage area of the base station and/or for being with a logical group of UEs determined by the base station.

In some implementations, the baseband circuitry 804 can include one or more audio digital signal processor(s) (DSP) 804F. The audio DSPs 804F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 804 and the application circuitry 802 can be implemented together such as, for example, on a system on a chip (SOC).

In some implementations, the baseband circuitry 804 can provide for communication compatible with one or more radio technologies. For example, in some implementations, the baseband circuitry 804 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 804 is configured to support radio communications of more than one wireless protocol can be referred to as multi-mode baseband circuitry.

RF circuitry 806 can enable communication with wireless networks using modulated electromagnetic radiation through a non-solid medium. In various implementations, the RF circuitry 806 can include switches, filters, amplifiers, etc. to facilitate the communication with the wireless network. RF circuitry 806 can include a receive signal path which can include circuitry to down-convert RF signals received from the FEM circuitry 808 and provide baseband signals to the baseband circuitry 804. RF circuitry 806 can also include a transmit signal path which can include circuitry to up-convert baseband signals provided by the baseband circuitry 804 and provide RF output signals to the FEM circuitry 808 for transmission.

In some implementations, the receive signal path of the RF circuitry 806 can include mixer circuitry 806A, amplifier circuitry 806B and filter circuitry 806C. In some implementations, the transmit signal path of the RF circuitry 806 can include filter circuitry 806C and mixer circuitry 806A. RF circuitry 806 can also include synthesizer circuitry 806D for synthesizing a frequency for use by the mixer circuitry 806A of the receive signal path and the transmit signal path. In some implementations, the mixer circuitry 806A of the receive signal path can be configured to down-convert RF signals received from the FEM circuitry 808 based on the synthesized frequency provided by synthesizer circuitry 806D. The amplifier circuitry 806B can be configured to amplify the down-converted signals and the filter circuitry 806C can be a low-pass filter (LPF) or band-pass filter (BPF) configured to remove unwanted signals from the down-converted signals to generate output baseband signals. Output baseband signals can be provided to the baseband circuitry 804 for further processing. In some implementations, the output baseband signals can be zero-frequency baseband signals, although this is not a requirement. In some implementations, mixer circuitry 806A of the receive signal path can comprise passive mixers, although the scope of the implementations is not limited in this respect.

In some implementations, the mixer circuitry 806A of the transmit signal path can be configured to up-convert input baseband signals based on the synthesized frequency provided by the synthesizer circuitry 806D to generate RF output signals for the FEM circuitry 808. The baseband signals can be provided by the baseband circuitry 804 and can be filtered by filter circuitry 806C.

In some implementations, the mixer circuitry 806A of the receive signal path and the mixer circuitry 806A of the transmit signal path can include two or more mixers and can be arranged for quadrature down conversion and up conversion, respectively. In some implementations, the mixer circuitry 806A of the receive signal path and the mixer circuitry 806A of the transmit signal path can include two or more mixers and can be arranged for image rejection (e.g., Hartley image rejection). In some implementations, the mixer circuitry 806A of the receive signal path and the mixer circuitry 1406A can be arranged for direct down conversion and direct up conversion, respectively. In some implementations, the mixer circuitry 806A of the receive signal path and the mixer circuitry 806A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 806 can include analog-to-digital converter (ADC) and digital-to-analog converter (DAC) circuitry and the baseband circuitry 804 can include a digital baseband interface to communicate with the RF circuitry 806.

In some dual-mode implementations, a separate radio IC circuitry can be provided for processing signals for each spectrum, although the scope of the implementations is not limited in this respect.

In some implementations, the synthesizer circuitry 806D can be a fractional-N synthesizer or a fractional N/N+1 synthesizer, although the scope of the implementations is not limited in this respect as other types of frequency synthesizers can be suitable. For example, synthesizer circuitry 806D can be a delta-sigma synthesizer, a frequency multiplier, or a synthesizer comprising a phase-locked loop with a frequency divider.

The synthesizer circuitry 806D can be configured to synthesize an output frequency for use by the mixer circuitry 806A of the RF circuitry 806 based on a frequency input and a divider control input. In some implementations, the synthesizer circuitry 806D can be a fractional N/N+1 synthesizer.

In some implementations, frequency input can be provided by a voltage-controlled oscillator (VCO), although that is not a requirement. Divider control input can be provided by either the baseband circuitry 804 or the applications circuitry 802 depending on the desired output frequency. In some implementations, a divider control input (e.g., N) can be determined from a look-up table based on a channel indicated by the applications circuitry 802.

Synthesizer circuitry 806D of the RF circuitry 806 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 806D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 806 can include an IQ/polar converter.

FEM circuitry 808 can include a receive signal path which can include circuitry configured to operate on RF signals received from one or more antennas 810, amplify the received signals and provide the amplified versions of the received signals to the RF circuitry 806 for further processing. FEM circuitry 808 can also include a transmit signal path which can include circuitry configured to amplify signals for transmission provided by the RF circuitry 806 for transmission by one or more of the one or more antennas 810. In various implementations, the amplification through the transmit or receive signal paths can be done solely in the RF circuitry 806, solely in the FEM circuitry 808, or in both the RF circuitry 806 and the FEM circuitry 808.

In some implementations, the FEM circuitry 808 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 806). The transmit signal path of the FEM circuitry 808 can include a power amplifier (PA) to amplify input RF signals (e.g., provided by RF circuitry 806), and one or more filters to generate RF signals for subsequent transmission (e.g., by one or more of the one or more antennas 810).

In some implementations, the PMC 812 can manage power provided to the baseband circuitry 804. In particular, the PMC 812 can control power-source selection, voltage scaling, battery charging, or DC-to-DC conversion. The PMC 812 can often be included when the device 800 is capable of being powered by a battery, for example, when the device is included in a UE. The PMC 812 can increase the power conversion efficiency while providing desirable implementation size and heat dissipation characteristics.

While FIG. 8 shows the PMC 812 coupled only with the baseband circuitry 804. However, in other implementations, the PMC 812 may be additionally or alternatively coupled with, and perform similar power management operations for, other components such as, but not limited to, application circuitry 802, RF circuitry 806, or FEM circuitry 808.

In some implementations, the PMC 812 can control, or otherwise be part of, various power saving mechanisms of the device 800. For example, if the device 800 is in an RRC_Connected state, where it is still connected to the RAN node as it expects to receive traffic shortly, then it can enter a state known as Discontinuous Reception Mode (DRX) after a period of inactivity. During this state, the device 800 can power down for brief intervals of time and thus save power.

If there is no data traffic activity for an extended period of time, then the device 800 can transition off to an RRC_Idle state, where it disconnects from the network and does not perform operations such as channel quality feedback, handover, etc. The device 800 goes into a very low power state and it performs paging where again it periodically wakes up to listen to the network and then powers down again. The device 800 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 802 and processors of the baseband circuitry 804 can be used to execute elements of one or more instances of a protocol stack. For example, processors of the baseband circuitry 804, alone or in combination, can be used execute Layer 3, Layer 2, or Layer 1 functionality, while processors of the baseband circuitry 804 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

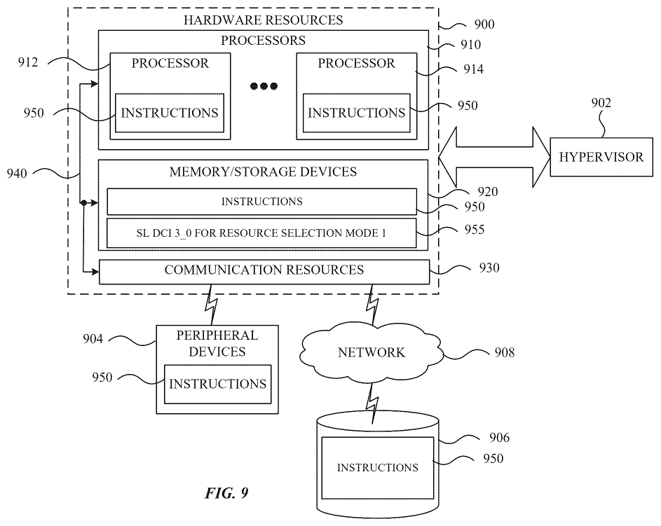

FIG. 9 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 9 shows a diagrammatic representation of hardware resources 900 including one or more processors (or processor cores) 910, one or more memory/storage devices 920, and one or more communication resources 930, each of which may be communicatively coupled via a bus 940. For implementations where node virtualization (e.g., NFV) is utilized, a hypervisor 902 may be executed to provide an execution environment for one or more network slices/sub-slices to utilize the hardware resources 900

The processors 910 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 912 and a processor 914.

The memory/storage devices 920 may include main memory, disk storage, or any suitable combination thereof. The memory/storage devices 920 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 920 may receive and store one or more configurations, instructions, and/or other information 955 for SL DCI 3_0 for resource selection mode 1. The SL DCI 3_0 955 may include frequency resource assignment information, time resource assignment information, CCA type information, time gap information, and CP extension information. The frequency resource assignment information may indicate whether a partial BW or a full BW is allocated to UE 110, and whether the assigned frequency resources are interlaced waveform resources or continuous waveform resources. The time resource assignment information may include a CCA type to be performed by the UE, a time gap between reception of the SL DCI 3_0 and a first SL transmission, and whether a CP extension is to be used during the SL communications (e.g., between completion of a CCA procedure and a first SL transmission or to ensure a gap between SL transmissions of a shared COT scenario are observed). The SL DCI 3_0 may also include multi-TTI scheduling information, which may include continuous SL transmissions or non-continuous SL transmissions. In such scenarios, the SL DCI 3_0 may also include HARQ information for one or more of the multi-TTI SL transmissions. In some implementations, SL DCI 3_0 may include multiple starting positions for SL transmissions. The starting positions may start at a slot boundary, start halfway between slot boundaries, and may depend on whether a partial BW or full BW is allocated to the UE. In some implementations, SL DCI 3_0 may include bi-directional SL DCI 3_0 transmitted by a base station to multiple UEs. The UEs may receive the bi-directional SL DCI 3_0 for being within a coverage area of the base station and/or for being with a logical group of UEs determined by the base station.

The communication resources 930 may include interconnection or network interface components or other suitable devices to communicate with one or more peripheral devices 904 or one or more databases 906 via a network 908. For example, the communication resources 930 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 950 may comprise software, a program, an application, an applet, an app, or other executable code for causing at least any of the processors 910 to perform any one or more of the methodologies discussed herein. The instructions 950 may reside, completely or partially, within at least one of the processors 910 (e.g., within the processor's cache memory), the memory/storage devices 920, or any suitable combination thereof. Furthermore, any portion of the instructions 950 may be transferred to the hardware resources 900 from any combination of the peripheral devices 904 or the databases 906. Accordingly, the memory of processors 910, the memory/storage devices 920, the peripheral devices 904, and the databases 906 are examples of computer-readable and machine-readable media.

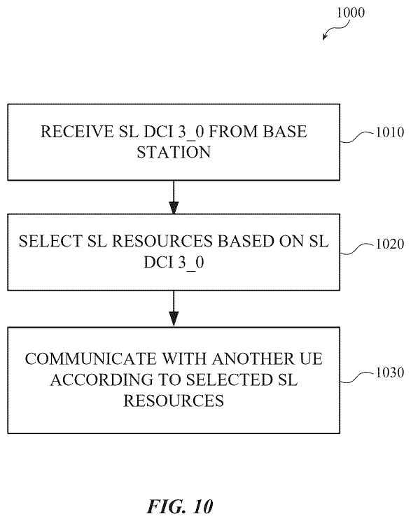

FIG. 10 is a diagram of an example process for using SL DCI 3_0 according to one or more implementations described herein. Process 1000 may be implemented by UE 110-1, UE 110-2, and base station 122. In some implementations, some or all of process 1000 may be performed by one or more other systems or devices, including one or more of the devices of FIG. 1. Additionally, process 1000 may include one or more fewer, additional, differently ordered and/or arranged operations than those shown in FIG. 10. In some implementations, some or all of the operations of process 1000 may be performed independently, successively, simultaneously, etc., of one or more of the other operations of process 1000. As such, the techniques described herein are not limited to a number, sequence, arrangement, timing, etc., of the operations or process depicted in FIG. 10.

As shown, process 1000 may include receiving SL DCI 3_0 from base station 122 (block 1010). For example, UE 110 may receive SL DCI 3_0 information from base station 122. In some implementations, the SL DCI 3_0 information may be received as part of a DG. In other implementations, the SL DCI 3_0 information may be received as part of a CG. As described herein, The SL DCI 3_0 955 may include frequency resource assignment information, time resource assignment information, CCA type information, time gap information, CP extension information, and more.

Process 1000 may also include selecting SL resources based on the SL DCI 3_0 (block 1020). For example, UE 110 may use the SL DCI 3_0 information to select SL resources based on the SL DCI 3_0 information. As described herein, this may include, for example, UE 110 processing the received SL DCI 3_0 information to identify SL resources indicated by the SL DCI 3_0 information. The SL resources may include frequency domain resources, time domain resources, performing a CCA procedure in accordance with the SL DCI 3_0 information, and more.

Process 1000 may include communicating with another UE 110 according to the selected SL resources (block 1030). For example, UE 110 may use resources selected based on the received SL DCI 3_0 information (e.g., frequency domain resources, timing domain resources, etc.) to transmit a SL signal to another UE 110. In some implementations, the SL signal may be in the unlicensed spectrum, UE 110 may transmit the signal in response to a successful CCA procedure, and the SL signal may initiate further SL communications (e.g., SL COT sharing) between the UEs 110.

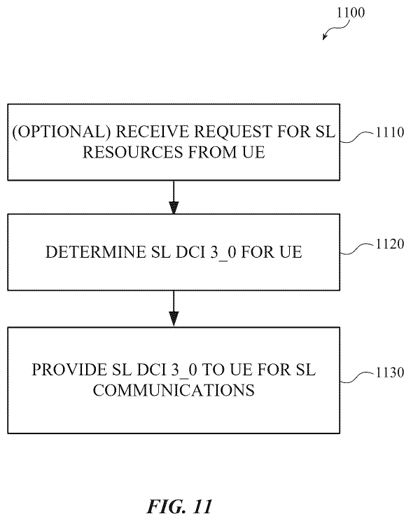

FIG. 11 is a diagram of an example process for providing SL DCI 3_0 according to one or more implementations described herein. Process 1100 may be implemented by UE 110-1, UE 110-2, and base station 122. In some implementations, some or all of process 1100 may be performed by one or more other systems or devices, including one or more of the devices of FIG. 1. Additionally, process 1100 may include one or more fewer, additional, differently ordered and/or arranged operations than those shown in FIG. 11. In some implementations, some or all of the operations of process 1100 may be performed independently, successively, simultaneously, etc., of one or more of the other operations of process 1100. As such, the techniques described herein are not limited to a number, sequence, arrangement, timing, etc., of the operations or process depicted in FIG. 11.

As shown, process 1100 may include receiving a request for SL resources from UE 110 (block 1110). For example, base station 122 may receive a request for SL resources from UE 110. The request for SL resources may correspond to a request for frequency domain resources, timing domain resources, etc., in the unlicensed spectrum. In some implementations, the request may correspond to a DG scenario.

Process 1100 may include determining SL DCI 3_0 for UE 110 (block 1120). For example, base station 122 may determine SL DCI 3_0 information for UE 110. In some implementations, such as a DG situation, base station 122 may determine the SL DCI 3_0 information in response to receiving a grant request or another type of request for SL resources. In some implementations, such as a CG situation, base station 122 may determine the SL DCI 3_0 information as a matter of course (e.g., as part of an attach procedure or another process). In some implementations, the SL DCI 3_0 information may be cell-specific, UE-specific, or UE group specific.

Process 1100 may include providing SL DCI 3_0 to UE for SL communications (block 1130). For example, base station 122 may transmit the SL DCI 3_0 information to UE 110. In some implementations, base station 122 may do so via a PDCCH to UE 110. In some implementations, RRC signaling may be used. As described herein, the SL DCI 3_0 information may enable UE 110 to establish SL communications with another UE 110.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, a user equipment (UE), may comprise: a memory; and one or more processors configured to, when executing instructions stored in the memory, cause the UE to: receive, from a base station, downlink control information (DCI) for communicating with another UE via sidelink (SL); select, based on the DCI, SL resources; and communicate with the another UE via SL in accordance with the SL resources. In example 2, which may also include one or more of the examples described herein, the DCI is DCI 3_0 for mode 1 SL resource selection.

In example 3, which may also include one or more of the examples described herein, the DCI comprises: frequency domain resources; time domain resources; a clear channel assessment (CCA) type; and a cyclic prefix (CP) extension. In example 4, which may also include one or more of the examples described herein, the DCI comprises a type 1 CCA and priority class based on a SL scheduling request (SR) and/or buffer status report (BSR). In example 5, which may also include one or more of the examples described herein, the DCI comprises a type 2 CCA when a scheduled transmission based on the DCI is within a shared channel occupancy time (COT) allocated to a different UE.

In example 6, which may also include one or more of the examples described herein, the DCI comprises a CP extension configured to enable SL communications involving a gap of a shared COT. In example 7, which may also include one or more of the examples described herein, the DCI comprises a CP extension based on whether a frequency domain resource of the DCI comprises a partial bandwidth (BW) or a full BW. In example 8, which may also include one or more of the examples described herein, a frequency domain resource of the DCI comprises partial BW and a start position for an SL transmission using the partial BW.

In example 9, which may also include one or more of the examples described herein, a frequency domain resource of the DCI comprises full BW and a set of start positions, for random selection, for an SL transmission using the full BW. In example 10, which may also include one or more of the examples described herein, the DCI comprises multi transmission time interval (multi-TTI) scheduling for SL transmissions. In example 11, which may also include one or more of the examples described herein, the DCI comprises a first hybrid automatic repeat request (HARQ) ID for a first TTI and the UE is to determine a subsequent HARD ID based on the HARQ ID for the first TTI.

In example 12, which may also include one or more of the examples described herein, the DCI comprises HARQ information for each transmission of the SL transmissions of the multi TTI scheduling. In example 13, which may also include one or more of the examples described herein, the DCI comprises multiple starting positions for the SL transmissions of the multi-TTI scheduling. In example 14, which may also include one or more of the examples described herein, the UE is configured to transmit using a second starting position for the SL transmissions when a CCA procedure is not successful before a first starting position for the SL transmissions.

In example 15, which may also include one or more of the examples described herein, the DCI comprises bi-directional DCI directed to the UE and the another UE., the bi-directional DCI comprising resource selections for the UE and the another UE. In example 16, which may also include one or more of the examples described herein, the frequency domain resource of the DCI comprises an interlaced waveform resource or a continuous waveform resource. In example 17, which may also include one or more of the examples described herein, a method, performed by a user equipment (UE), may comprise: receiving, from a base station, downlink control information (DCI) for communicating with another UE via sidelink (SL); selecting, based on the DCI, SL resources; and communicating with the another UE via SL in accordance with the SL resources.

In example 18, which may also include one or more of the examples described herein, a base station, may comprise: a memory; and one or more processors configured to, when executing instructions stored in the memory, cause the base station to: determine downlink control information (DCI) for sidelink (SL) resource selection; and communicate the DCI to a UE. In example 19, which may also include one or more of the examples described herein, a method, performed by a base station, may comprise: determining downlink control information (DCI) for sidelink (SL) resource selection; and communicating the DCI to a UE.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

1. An apparatus for a user equipment (UE), comprising:
a memory; and
one or more processors, when executing instructions stored in the memory, configured to:
receive, from a base station, downlink control information (DCI) for communicating with another UE via sidelink;
select, based on the DCI, sidelink resources; and
communicate with the another UE using the sidelink resources,
wherein the DCI includes frequency resource assignment information indicating whether assigned frequency resources are interlaced waveform resources or continuous waveform resources.

2. The apparatus of claim 1, wherein the DCI is DCI 3_0 for mode 1 sidelink resource selection.

3. The apparatus of claim 1, wherein the DCI further includes:
time domain resources;
a clear channel assessment (CCA) type; and
a cyclic prefix (CP) extension.

4. The apparatus of claim 1, wherein the DCI comprises a type 1 CCA and priority class based on a sidelink scheduling request (SR) and/or buffer status report (BSR).

5. The apparatus of claim 1, wherein the DCI comprises a type 2 CCA when a scheduled transmission based on the DCI is within a shared channel occupancy time (COT) allocated to a different UE.

6. The apparatus of claim 1, wherein the DCI comprises a CP extension configured to enable sidelink communications involving a gap of a shared COT.

7. The apparatus of claim 1, wherein the DCI comprises a CP extension based on whether a frequency domain resource of the DCI comprises a partial bandwidth (BW) or a full BW.

8. The apparatus of claim 1, wherein a frequency domain resource of the DCI comprises partial BW and a start position for a sidelink transmission using the partial BW.

9. The apparatus of claim 1, wherein a frequency domain resource of the DCI comprises full BW and a set of start positions, for random selection, for a sidelink transmission using the full BW.

10. The apparatus of claim 1, wherein the DCI comprises multi transmission time interval (multi-TTI) scheduling for sidelink transmissions.

11. The apparatus of claim 10, wherein the DCI comprises a first hybrid automatic repeat request (HARQ) ID for a first TTI and the UE is to determine a subsequent HARD ID based on the HARQ ID for the first TTI.

12. The apparatus of claim 10, wherein the DCI comprises HARQ information for each transmission of the sidelink transmissions of the multi TTI scheduling.

13. The apparatus of claim 10, wherein the DCI comprises multiple starting positions for the sidelink transmissions of the multi-TTI scheduling.

14. The apparatus of claim 13, wherein the UE is configured to transmit using a second starting position for the sidelink transmissions when a CCA procedure is not successful before a first starting position for the sidelink transmissions.

15. The apparatus of claim 10, wherein the DCI comprises bi-directional DCI directed to the UE and the another UE, the bi-directional DCI comprising resource selections for the UE and the another UE.

16. The apparatus of claim 1, wherein the frequency resource assignment information is based on a RRC configuration of a parameter value in a sidelink bandwidth part configuration (SL-BWP-Config) information element (IE).

17. A method, performed by a user equipment (UE), comprising:
receiving, from a base station, downlink control information (DCI) for communicating with another UE via sidelink;
selecting, based on the DCI, sidelink resources; and
communicating with the another UE using the sidelink resources, wherein the DCI includes frequency resource assignment information indicating whether assigned frequency resources are interlaced waveform resources or continuous waveform resources.

18. The method of claim 17, wherein the frequency resource assignment information is based on a RRC configuration of a parameter value in a sidelink bandwidth part configuration (SL-BWP-Config) information element (IE).

19. A base station, comprising:
a memory; and
one or more processors configured to, when executing instructions stored in the memory, cause the base station to:
send a RRC configuration parameter indicating whether a sidelink bandwidth part (SL-BWP) is (pre-)configured with interlaced waveform resources;
based on the RRC configuration parameter, determine downlink control information (DCI) for sidelink resource selection; and
communicate the DCI to a UE for communicating with another UE.

20. The base station of claim 19, wherein the DCI includes frequency resource assignment information indicating whether assigned frequency resources are interlaced waveform resources or continuous waveform resources.
